(19) United States
(12) Patent Application Publication
(10) Pub. No.: US 2024/0393942 A1
(43) Pub. Date: Nov. 28, 2024

(54) MULTILINGUAL INTEGRATION SERVICE DEVICE AND METHOD USING EXPANDABLE KEYBOARD

(71) Applicant: Soon Jo WOO, Seongnam-si (KR)

(72) Inventor: Soon Jo WOO, Seongnam-si (KR)

(73) Assignee: Soon Jo WOO, Seongnam-si Gyeonggi-do (KR)

(21) Appl. No.: 18/682,413

(22) PCT Filed: Oct. 7, 2022
(86) PCT No.: PCT/KR2022/015107

§ 371 Date: Feb. 8, 2024

(30) Foreign Application Priority Data
Aug. 10, 2021 (KR) 10-2021-0105146

(51) Int. Cl. G06F 3/04886; G06F 3/023; G06F 9/451; G06F 40/58

(52) U.S. Cl. CPC G06F 3/04886; G06F 3/0236; G06F 9/454; G06F 40/58

(57) ABSTRACT

This invention relates to a method of improving the convenience and efficiency of services related to the input and output of multiple languages in a mobile environment in a virtual keyboard of a mobile device consisting of an input part, an operation part, and an output part, or a virtual keyboard in a metaverse such as holographic interface or augmented reality simulating the same, based on function buttons arranged around buttons assigned with characters, and language service functions such as speech recognition, speech synthesis, and machine translation functions assigned to the function buttons, by touching said function buttons to cause a plurality of registered input languages or translation target languages to be displayed on an expanded keypad, and selecting a language icon activated on the expanded keypad to determine a language to be used and input, translation, or speech synthesis to be performed in such language.

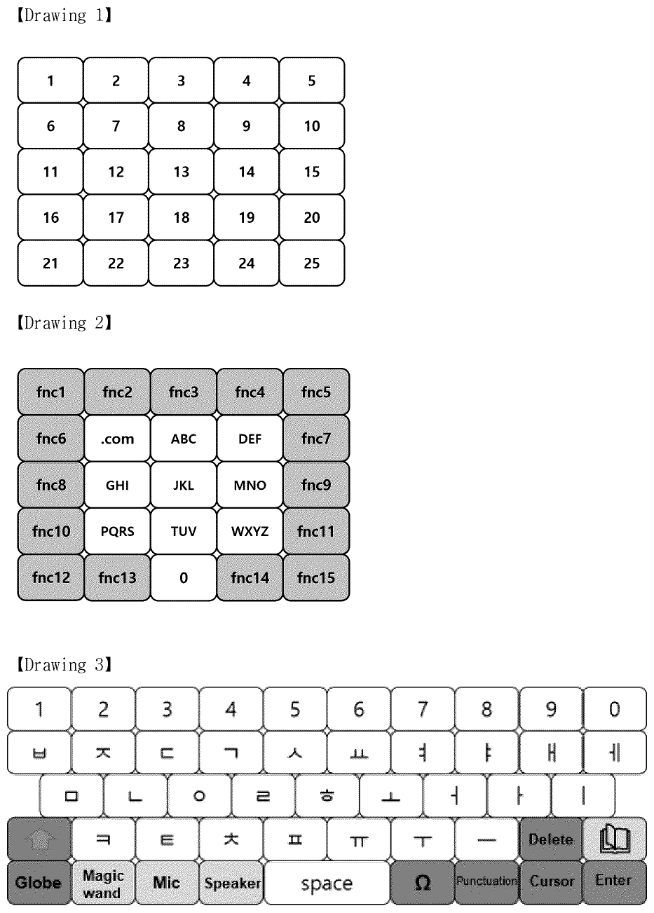

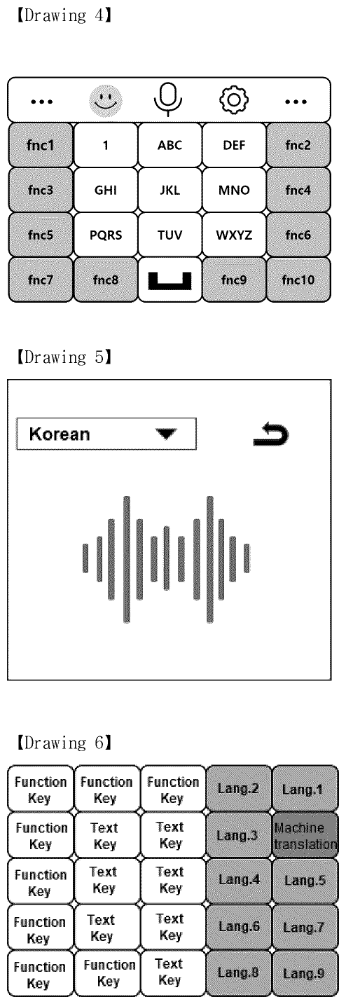

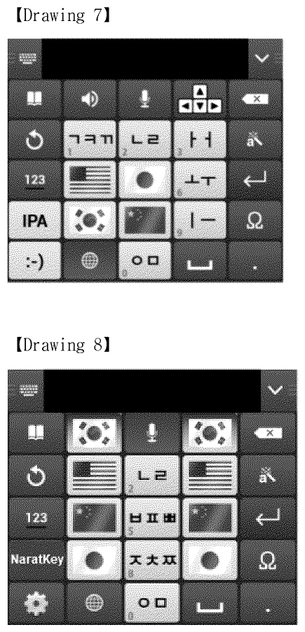

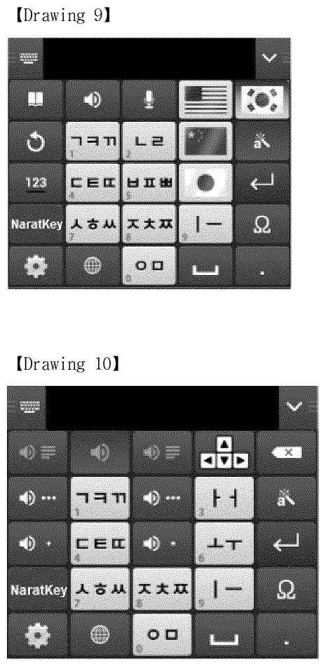

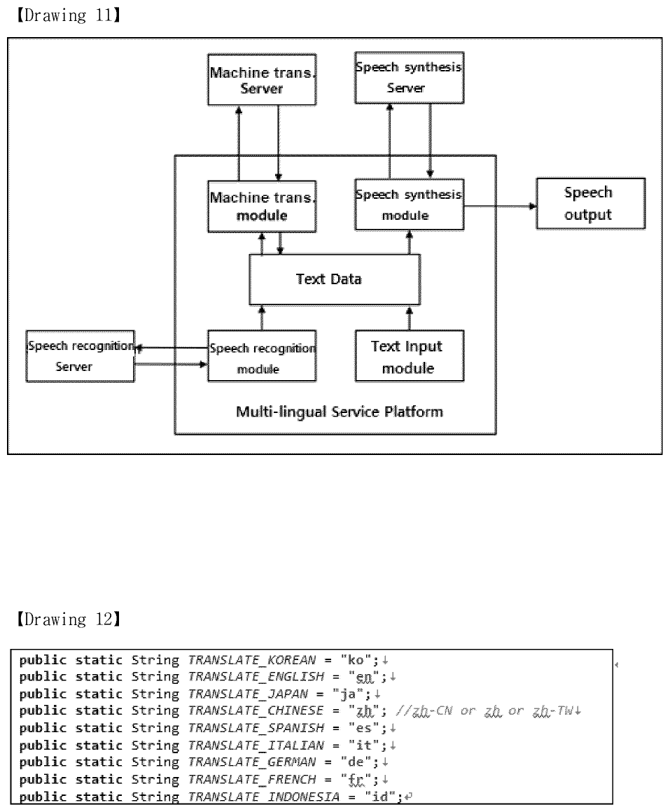

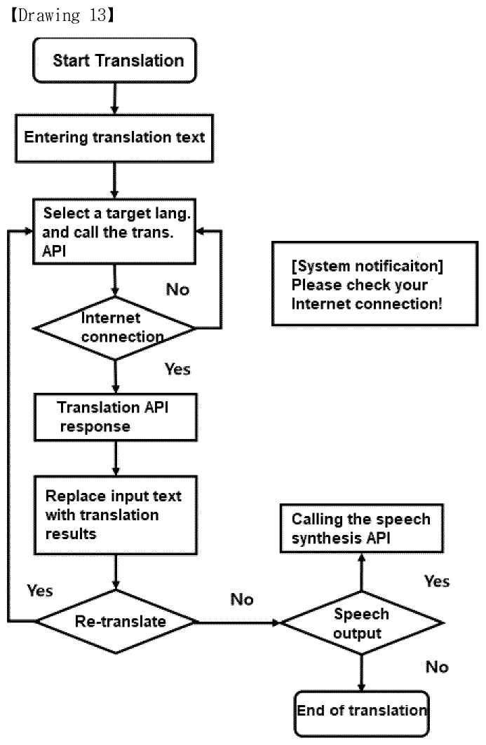

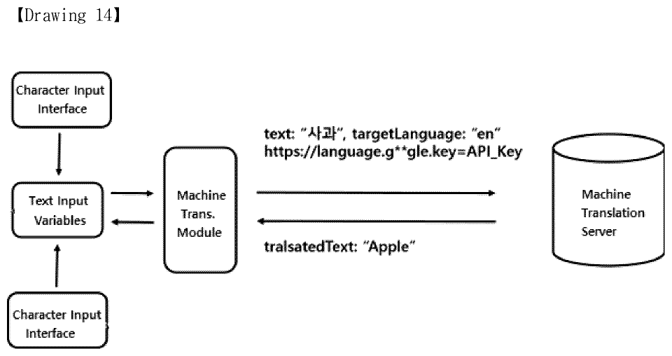

### TECHNICAL FIELD

The present invention relates to a method of supporting efficient and convenient language activities of users by integrating and providing services related to input and output of natural language, such as text input, speech recognition, machine translation, and speech synthesis, using an extended keypad in any mobile computing device consisting of input, computation, and output, which includes a personal computer, a smartphone, a tablet PC, or a smartwatch, and in holographic or augmented reality simulating the same.

### Technology Behind the Invention

Mobile devices represented by smartphones are convenient for users to carry, but the user interface for language input and output is inconvenient compared to personal computers. For convenience of portability, weight and size reduction is inevitable. As the size decreases, the size of the display to output the processing results also decreases. Since mobile devices such as smartphones do not have a separate input like a personal computer's keypad, it is common practice to apply touch-sensitive functions to the output—the display—and use some areas of the display as a virtual keypad.

As a result of dividing the small touchscreen screen and using it as a virtual keypad, the size of each button assigned to a character is small and the spacing between the buttons is dense, resulting in frequent typos during the input process.

To solve the aforesaid inconvenience of virtual keypads, speech recognition technology has been introduced.

As in the Sogou input device illustrated in Drawing 4, methods have been devised to assign a speech recognition function to a specific button on a menu bar independent of the keypad and use it to input characters. One of the aforesaid methods is a method that functions independently of the keypad, such that the user interface (GUI) of the virtual keypad is stopped when the speech recognition function is activated and the keypad is activated again when the back button is selected in the speech recognition interface, as illustrated in Drawing 5.

### DETAILS OF THE INVENTION

### Problems to be Solved by the Invention

In the method above, even though the buttons activating various functions are placed adjacent to each other, each function operates independently of each other.

Google's machine translation service is delivered as a web app with a responsive design to work in mobile browsers and is designed to be used to enter text into a source language input box using a keypad. As an alternative method of text input, touching the microphone icon displayed on the web app is designed to trigger the voice recognition function through the microphone function of the mobile device.

As one of the commercially available machine translation apps, NAVER's Papago has a menu bar with a microphone icon at the center to input the source language expression using speech recognition. Touching the menu bar activates the voice recognition interface, and pressing the microphone button enables voice recognition. If the user wants to enter the translation using a text input device, he/she can invoke the text input device by touching the input window.

In order to record the translation results in a separate document in the Papago translation app, it should be activated by pressing the share button at the bottom and selecting the app to use.

As mentioned above, existing language service apps have text input and voice recognition functions as well as machine translation functions for language processing that are implemented independently, so it is inconvenient and inefficient to switch between these functions or use them in conjunction.

### Solutions for the Problems

According to one aspect of the present invention to solve the abovementioned challenges, user convenience can be improved by programming a module in charge of a machine translation function (hereinafter referred to as a “machine translation module”) or a module in charge of a speech synthesis function (hereinafter referred to as a “speech synthesis module”) to perform their respective functions by referring to the same variable that stores a string input via a module in charge of character input (hereinafter referred to as a “character input module”), and to record the results of processing by some or all of said modules back to the variable where said string is stored.

The module responsible for the speech recognition function (hereinafter referred to as the “speech recognition module”) may store the results of the speech recognition processing in a variable where the character input module stores strings.

In some embodiments of the present invention, a user may assign all or some of the language-related functions such as speech recognition functions, speech synthesis functions, machine translation functions, etc. to different function buttons arranged around the button assigned a character, and touch the corresponding button to execute the function.

In some embodiments of the present invention, a user may embed one or more languages in one or more of said function buttons, and touching each of the function buttons may cause an expanded keypad showing the embedded language to be displayed around the function button; selecting any one of the languages may cause the selected function to be executed with respect to the selected language.

For example, when assigning a machine translation function to one of the function buttons, selecting any one of the keys of the expansion panel activated by pressing the machine translation button may cause the language assigned to the selected button to be set as a target language so that the entered character data is translated into the target language.

In one embodiment of the invention, selecting any one of the keys on the expansion panel activated by pressing the speech recognition button—which is one of the function buttons—may cause the language code assigned to the selected button to be sent along with a sound wave file to a speech recognition server for speech recognition in such language, returning a result encoded in characters of such language.

In one embodiment of the present invention, when any of the function buttons above is selected—such as an expanded keypad of the input keypad change function, an expanded keypad of the speech recognition button, or an expanded keypad of the machine translation button—the language code of the selected button may be stored in a specific variable for reference by the speech synthesis interface.

The language code selected in the expanded keypad of the input keypad change button can be stored in a variable tentatively named “currentKeypadCode”. The language code selected in the expanded keypad of the speech recognition button may be stored in a variable tentatively named “currentSttCode”. The language code selected in the expanded keypad of the machine translation button may be stored in a variable tentatively named “currentMtCode”. Whenever a new language code is entered in the abovementioned “current KeypadCode”, “currentSttCode”, and “currentMtCode”, the language code may be stored in a variable tentatively named “latestLangCode”.

When one of the function buttons above with speech synthesis function is selected, the speech synthesis program can refer to the language code stored in “latestLangCode”, copy the text data displayed on the text input window and send it to the speech synthesis server for speech synthesis, and return the resulting audio file in such language.

In some embodiments of the present invention, strings inputted via a text input module or a speech recognition module can be stored in a variable tentatively named “inputTextStore”. The speech recognition function module, speech synthesis function module, and machine translation function module associated with language input and output can all be implemented to reference the “inputTextStore” variable. This allows the strings entered using a text input module or a speech recognition module to be referenced as input to the machine translation module, and the strings entered or the output of machine translation to be referenced as input to the speech synthesis module.

In some embodiments of the invention, all or part of a library that performs speech recognition, speech synthesis, and machine translation functions may be mounted on the input platform to perform these functions without communication with a server.

In some embodiments of the invention, the modules responsible for speech recognition, speech synthesis, and machine translation functions can communicate with a remote server performing the respective functions via an open API to return the results of performing the respective functions.

In some embodiments of the present invention, a user may add a particular language keypad to the list of languages to be used from among the languages provided by the input platform via the settings menu so that the speech recognition function, speech synthesis function, and machine translation function associated with the added language are simultaneously added to the expanded keypad of the assigned button.

In some embodiments of the present invention, when deleting a particular language from the user-selected language list, functions synchronized with the language to be deleted such as speech recognition function, speech synthesis function, and machine translation function associated with the language to be deleted may be simultaneously deleted from the respective function button's expansion panel.

In some embodiments of the present invention, the synchronized addition of speech recognition function button, speech synthesis function button, and machine translation function button can be implemented so that the languages registered by the user to be synchronized in advance through the settings menu are activated and displayed around the pressed button in a preset order when the button is pressed.

### Effects of the Invention

By constructing a multilingual integrated service platform incorporating a text input module, a speech recognition module, a machine translation module, and a speech synthesis module as described above, and enabling the machine translation module or the speech synthesis module to refer to or change a variable that stores a string inputted through the text input module or the speech recognition module, a user can translate the input text data into a desired target language using the machine translation module and synthesize the translated result into speech using the speech synthesis module.

In addition, the modules related to the language service above can be configured to support multiple languages simultaneously, so that not only input but also translation can be made in one or more languages, and the result can be outputted as pronunciation in various languages through the speech synthesis module that supports various languages.

The multilingual integrated service platform above enables a user to use multiple languages freely at the same time, as well as users of various languages in various regions to communicate with each other through a single platform.

### BRIEF EXPLANATION OF THE DRAWINGS

DRAWING 1 illustrates one embodiment of a multilingual integrated service platform structure that includes a 3×4 character input keypad. The drawing shows that the buttons may be numbered sequentially from top left to bottom right.

DRAWING 2 illustrates the placement of function buttons and a 3×4 keypad for character input on the basic structure of DRAWING 1.

DRAWING 3 illustrates one embodiment of the arrangement of the function buttons included in DRAWING 3 on a QWERTY keypad.

DRAWING 4 illustrates a 3×4 keypad layout for the Sogou input device with the addition of a bar of function buttons, including the voice recognition function button, emoticon button, and settings menu button.

DRAWING 5 illustrates one embodiment of the voice recognition interface that is activated by touching the microphone icon on the function button bar, as in the Sogou input device of DRAWING 4.

DRAWING 6 illustrates an expansion bar that is activated by touching the machine translation button, assuming that the machine translation function is assigned to the “FNC7” button in DRAWING 2, which corresponds to button position 10 in DRAWING 1. Selecting any of the buttons in the abovementioned expanded keypads may cause the language code assigned to the selected button to dictate the target language.

DRAWING 7 illustrates an embodiment of a keypad change extension that is activated by touching the keypad change button while a Korean 3×4 keypad is selected, if the keypad change function is assigned to the “FNC22” button in DRAWING 2 corresponding to position 22 in DRAWING 1.

DRAWING 8 illustrates an embodiment of a voice recognition candidate language expanded keypad that is activated by touching the button when a voice recognition function is assigned to the “FNC3” button of DRAWING 2 corresponding to position 3 of DRAWING 1.

DRAWING 9 illustrates an embodiment of a machine translation target language expanded keypad that is activated when the button is touched, if a machine translation function is assigned to the “FNC7” button of DRAWING 2 corresponding to position 10 of DRAWING 1.

DRAWING 10 illustrates an embodiment of a speech synthesis expanded keypad that is activated by touching the speech synthesis button when the speech synthesis function is assigned to the “FNC2” button of DRAWING 2 corresponding to position 2 of DRAWING 1. It exemplifies how each button of the speech synthesis expanded keypad may be assigned “full text synthesis”, “word synthesis”, and “syllable synthesis” functions.

DRAWING 11 illustrates the interaction of modules responsible for the text input function, speech recognition function, machine translation function, and speech synthesis function integrated into a multilingual integrated service platform. The text data entered by the user using the text input module or the speech recognition module is stored in a variable tentatively named “input TextStore” and displayed on the screen. The machine translation module sends the text data to the machine translation server for translation, and replaces the value stored in the “inputTextStore” variable with the result returned from the machine translation server. The speech synthesis module transmits the audio file that is sent and received from the speech synthesis server by referring to the “inputTextStore” variable and “latestLangCode” variable to the speech output device.

DRAWING 12 illustrates a portion of source code representing constants that store target language codes that correspond to each key on the expanded keypad that is activated by touching a button assigned with the machine translation function as illustrated in DRAWING 9.

DRAWING 13 is a flowchart illustrating one embodiment of a process by which a machine translation service operates when provided via communication with a remote server. The flowchart illustrates that machine translation may be performed in an initially selected target language, and then the translation results may be used as input to iterate on translation into another language.

DRAWING 14 is a conceptual diagram illustrating an example service procedure performed by the machine translation module when the machine translation service is provided via a remote server as in DRAWING 13, and English is selected as a target language by touching the machine translation button.

### DETAILED DESCRIPTION OF THE INVENTION

The advantages and features of the present invention and methods of achieving them will become apparent upon reference to the embodiments described in detail in conjunction with the attached drawings. However, the invention is not limited to the embodiments disclosed herein and may be embodied in many different forms; these embodiments are provided merely to make the disclosure of the invention complete and to inform fully ordinary skills in the art where the invention belongs on the scope of the invention, and the invention is defined by the scope of the claims.

The terminology used in this specification is intended to describe embodiments, not to limit the invention. In this specification, the singular includes the plural unless the context mentions otherwise. As used in the specification, “includes” and/or “including” does not exclude the presence or addition of one or more other components in addition to those mentioned. Throughout the specification, the same drawing designation refers to the same component, and “and/or” includes each and every combination of one or more of the components mentioned.

In the present invention, the term user is intended to include any group or organization of people, including a person in the ordinary sense of the term, or any computing device or service operated by them.

In the present invention, keys and buttons of a virtual keyboard are used interchangeably.

In the present invention, a virtual keyboard is used for convenience of description only and is intended to include a physical keyboard on a personal computer.

In the present invention, the expression “pressing a button” or “a button is pressed” is used interchangeably with “touching a button” or “a button is touched”.

In the present invention, a module refers to a function or a program consisting of a number of functions that perform a specific function.

In the present invention, the expression “to select” or “to be selected” refers to the act of touching a particular button for the first time, or to the act of further touching or dragging a button on one of the expanded keypads activated by the selection of a particular button.

The expression “a particular button is assigned a function” or “assigning a function to a particular button” is used in the present invention to mean that touching said particular button calls a program that performs a function associated with the particular button or causes an event that calls the program.

In the present invention, the term “language list” is used in an inclusive sense to include “language keypads list”, “user STT list”, and “user MT list”.

In the present invention, a program may include both an independent program developed to perform a particular operation on a computing device or a function built into a computing device that performs said function, or the functions defined in a programming language.

Unless otherwise defined, all terms used herein (including technical and scientific terms) are intended to have the meaning commonly understood by one of ordinary skill in the art where the present invention belongs. Furthermore, commonly used predefined terms are not to be construed as anomalous or excessive unless expressly defined specifically.

Hereinafter, embodiments of the present invention will be described in detail with reference to the attached drawings. A computing device (not shown) implementing the present invention includes an input part, an operation part, and an output part.

The input part receives a touch signal from a user. The operation part operates the touch signal input from the user in a specified manner by referring to data stored in memory or data automatically generated by a specified program to information stored in memory, and stores the result of the operation in a specified variable. The output part outputs the calculation result. The input and output can be provided as a unit. For example, the input may be a touch sensor and the output may be a display panel. In addition, a touch screen panel may be provided wherein the input and output are integrally configured. However, the present invention is not limited to this. A microphone may be provided as an input when a button assigned with a voice recognition function is touched. A computer monitor may be provided as an output part.

As illustrated in DRAWING 1, in one embodiment of the present invention, the user graphical interface (hereinafter “GUI”) of a multilingual service platform including a 3×4 keypad is assigned button numbers from left to right and top to bottom. The top leftmost button is assigned number 1; to the right, a number increasing by 1 is assigned sequentially. The last line is assigned numbers 21 through 25 according to the scheme above.

In the GUI above for a 3×4 keypad on a multilingual platform, buttons 7, 8, 9, 12, 13, 14, 17, 18, 19, and 23 can be used to enter characters, and the remaining buttons can be assigned specific functions. The keypad arrangement above is intended only to make the disclosure of the present invention complete; various keypad arrangements are possible aside from the keypad arrangement above.

In one embodiment of the present invention, the user can access the settings menu via the settings function button assigned to button 21 of the GUI for the 3×4 keypad. Selecting the Settings button calls the Environment Setting Manager program, which displays a menu bar with various functions available to the user. The user can add additional languages to be used through the Add Language function provided in the Settings menu. When the Add Language menu is selected, a list of languages is presented wherein some or all of the character input function, speech recognition function, speech synthesis function, and machine translation function are provided in the multilingual integrated service platform of the present invention. By selecting any of the languages included in the language list, the selected language is stored in the “user language keypad list”. The “user language keypad list” may be stored in a variable in the form of an array, in a file with a specific name, or in a specific table in a database. As exemplified in DRAWING 7, the Environment Setting Manager program of the character input interface references the languages stored in the user language list and activates and displays them on the extended keypad of the change keypad function button sequentially in a preset order of adding languages, according to the order in which they are registered by referring to the flag icons of the corresponding languages stored in the flag icon directory.

In one embodiment of the present invention, languages added by the user via the Add Language menu in a manner similar to that described above may be stored in a separate list simultaneously with the “user language keypad list”. For example, languages added to the user language list can be stored simultaneously in a tentative “user STT list” and a “user MT list”. The “user STT list” and “user MT list” may be stored in an array of variables—similar to the user language list—or in a file with a specific name, or in a specific table in a database depending on the need and convenience.

In one embodiment of the invention, as exemplified in DRAWING 8, the Environment Setting Manager program-referring to the list of languages contained in the “user STT list” above, activates and displays them on the expanded keypad of the speech recognition function button in a preset order of adding languages sequentially according to the registered order, referring to the flag icons of the corresponding languages stored in the flag icon directory.

In one embodiment of the invention, a machine translation function may be assigned to button 10 as illustrated in [Drawing 9], and a list of target languages stored in the “User MT List” may be arranged around the machine translation button in a preset order when the machine translation button is touched.

If the machine translation button is touched and then released while being dragged to the “Language 1” button on the expanded keypad, the language service is determined to be “Machine Translation” by the location of the first-touched button 10 and the language code of the dragged target language is determined to be “Language 1”.

In one embodiment of the invention, the Environment Setting Manager program can refer only to the “user language keypad list” to assign the same language candidates to the buttons assigned to the keypad change function, the buttons assigned to the speech recognition function, and the expanded keypad that is activated when the buttons assigned to the machine translation are pressed.

In one embodiment of the invention, the function buttons set on a 3×4 keypad can be appropriately positioned around the buttons assigned numbers and letters, as illustrated in DRAWING 3 for a QWERTY keyboard.

In one embodiment of the present invention, when a button assigned a speech recognition (STT) function is selected with a specific language icon selected on the expanded keypad activated through the process above, the STT_Langcode required by the open API is set by calling autoLocale.setSTTLanguage with the STT language code after referring to the language code of the selected icon by referring to languageCode. The voiceInput function is called using the STT_Langcode above. The voice Input function checks for audio permissions and, if any, calls the inputService's startVoiceInput method. In the startVoiceInput method, sttIntent is set to Lang_code with the speechInit function and the speech recognition listener is created and started with the speechStart function. The Lang_code and sound wave file are sent to the speech recognition server and the processing results are returned. When the speech recognition is complete, the user can iterate over the matched results in the speech recognition listener's onResults function to store the matched results in the “inputTextStore” variable and output them to the screen.

In one embodiment of the present invention, the machine translation service may utilize the Google Cloud Platform (GCP) translation service. The GCP translation service requires a Credentials_translate.json file. When a target language icon is selected in an expanded keypad that is activated after selecting a button assigned a machine translation function, the information in the keypadLanguage of the selected icon is used to set the TRANSLATE_LANGCODE value of the AutoLocale.setTranslateClancode function called through the selection of the machine translation button. The translate function is called with the changed TRANSLATE_LANGCODE. The translate function calls the inputService.checkTranslate function. If the Internet connection is not checked in the checkTranslate function, it notifies the user with a toast message to check the Internet connection status; if the Internet is connected, it calls getTranslateService( ) and startTranslate(lang_code). The getTranslateService function reads the credentials_translate.json file to authorize the translation service. After setting the langcode through the startTranslate function, the translation is requested by referencing the “inputTextStore” variable. When the result is returned from the GCP translation service server, the data stored in “inputTextStore” is deleted, and the translation result is saved and outputted to the screen.

In one embodiment of the invention, the operation of the speech synthesis module can be implemented similar to the operation of the machine translation module.

In one embodiment of the invention, the input of text data can be done in a “copy and paste” manner. In this case, the language code of the entered text can be stored in “latestLangCode” with reference to the result of the language identification program.

In one embodiment of the invention, each incoming sentence can be assigned a language code and stored in a hash function. The address of the hash function may be stored in a tentative “inputTextStore” that stores character data. The machine translation module or speech synthesis module can be implemented to perform machine translation or speech synthesis on a sentence-by-sentence basis by referring to the key values and value values of the hash function items stored in “inputTextStore”.

1. A multilingual integrated service platform consisting of a plurality of character buttons and a plurality of function buttons, function buttons assigned a speech recognition function, a machine translation function, and a speech synthesis function,
wherein selection of any one of the function buttons above activates an expanded keypad displaying an icon of a target language in which the function is serviced, and
wherein selection of any one of the function buttons of the expanded keypad causes the selected function to be performed with respect to the selected language.

2. A multilingual integrated service platform consisting of a plurality of character buttons and a plurality of function buttons, the buttons invoking modules that perform a keypad change function, the speech recognition function, the machine translation function, and the speech synthesis function,
wherein the modules performing the keypad change function, speech recognition function, machine translation function, and speech synthesis function can commonly reference or change a variable that stores character data.

3. A method of synchronizing the keypad selection button, speech recognition button, speech synthesis button, and machine translation button on a virtual keyboard so that the result is simultaneously reflected on the function buttons above when a language to be used is added or deleted.

4. A method of determining a service language by storing a language code of incoming character data in a specific variable and referring to it.
